(19) United States
(12) Patent Application Publication
(10) Pub. No.: US 2002/0032863 A1
(43) Pub. Date: Mar. 14, 2002

(54) System and method for performing digital watermarking in realtime using encrypted algorithm

(75) Inventor: Jae Ho Ha, Pyongtaek City (KR)

Correspondence Address: BOURQUE & ASSOCIATES, P.A., 835 HANOVER STREET, SUITE 303, MANCHESTER, NH, 03104, US

(73) Assignee: Contents-Korea Co., Ltd.

(21) Appl. No.: 09/839,067

(22) Filed: Apr. 20, 2001

(30) Foreign Application Priority Data
Apr. 26, 2000 (KR) 2000-22230

(51) Int. Cl. H04L 9/00

(52) U.S. Cl. 713/176

(57) ABSTRACT

A realtime digital watermarking using an encrypted algorithm allows a user client to have a user key for user authentication when the user client gains access to the Internet. If a user key for user authentication is assigned to a user client and then the user client having accessed the computer network such as the Internet requests content, a duplication process (history) of the contents is watermarked and then transferred to the requested contents in realtime. Moreover, an encrypted algorithm is added in the watermarking process, to thereby avoid alteration or damage due to abnormal extraction of the watermarked information. For this reason, it is not necessary to watermark digital contents each time when the digital contents are produced. Further, since a duplication process (history) of contents including a user identification (ID) and a user key other than a simple, fixed text or textual pattern is watermarked, it is possible to obtain a more assured and effective content protection.

### FIELD OF THE INVENTION

The present invention relates to a digital watermarking technology for concealing an authentication mark in digital multimedia content, such that an original author (i.e. copyrighter) of the contents can be identified, and more particularly, to a digital watermarking system for watermarking a content's duplication process (history) in realtime, using an encrypted algorithm when contents are requested for on the Internet, and an operating method therefore.

### DESCRIPTION OF THE RELATED ART

Existing analog-patterned information requires a large storage area as has associated with significant costs, whereas digitized information has an associated lower cost and consumes little amount of storage space. Thus, various organizations utilize digital information for many projects including for establishing an electronic library, an electronic museum and so on through digitized information. Existing printed materials are scanned and then the scanned materials are provided via the Internet.

The digitized materials can be distributed without having any differences between an original copy and a duplication copy. In the case of duplication of an existing printed medium, it is possible to tell an original copy from a duplication copy due to a qualitative difference between the original copy and the duplication copy. That is, since illegally duplicated contents of text books, and audio and video tape are lowered in quality in the past, the number of duplication copies which can be reproduced from an original copy has been limited. The qualitative distortion of information can prevent a lot of infringement.

However, since digital information has no difference between an original copy and a duplication copy, the contents thereof can be altered by a user at his or her desire, and the cost therefore is not expensive. Thus, the digital information can be easily exposed to potential infringement.

Multimedia resources are now being distributed through the world-wide-web or digital networks, and commercial interests of the multimedia resources has become a matter of concern. An encryption of the digital information becomes necessary at the urging of a copyrighter of digital information. Watermarking has been proposed as an alternative method.

Digital watermarking means that a digitized message (watermark) is concealed in digital contents and is extracted from the digital contents via a computer. The watermark is not seen and listened to, differently from a traditional watermark that is seen under a certain condition.

Contents providers that produce music files and provide them on the Internet hide their own unique symbols (watermarks) in the music files that are produced, in order to detect and help prevent illegal duplication and effectively protect copyright ownership.

When pictures are taken using a digital camera and then made into digital images, watermarks are inserted into the pictures. Otherwise, when image files are produced using a tool such as Photoshop, which is an image production tool, watermarks are inserted into the image files. In addition, a method for concealing their own codes is used in the case of production of digital pictures.

However, currently available digital watermarking is burdensome since it requires that a watermark should be inserted into digital contents each time when the digital contents are produced. In the case that a different watermark is inserted into individual contents such as if a product number (serial number) is assigned to each product, it is not so easy to hold and manage the watermark.

Also, since watermarks inserted into digital contents are composed of simple texts or patterns, it is easy to alter, counterfeit or damage the watermarks.

### SUMMARY OF THE INVENTION

To solve the above problems, it is an object of the present invention to provide a digital watermarking system and an operating method therefore, in which a contents duplication process (history) is watermarked based on automatic execution of a watermarking program using an encrypted algorithm, if duplication or download of digital contents occurs by an external accessing person on the Internet.

To accomplish the above object of the present invention, there is provided a realtime digital watermarking system using an encrypted algorithm, the digital watermarking system comprising: an operator server for storing and providing contents, creating and assigning a user key for authentication to an accessing person, watermarking a corresponding contents duplication process (history) on the contents requested for by the accessing person using the authentication user key, in realtime and extracting watermarked information from the watermarked contents; a user client having accessed the operator server, for requesting for and receiving necessary contents from the operator server; and the Internet network connecting the operator server and the user client.

According to another aspect of the present invention, there is also provided an operating method for running a realtime digital watermarking system, the operating method comprising the steps of: creating a user key for user authentication and issuing the user key to a log-in person having accessed an operator server, using a previously registered user's identification (ID); the user requesting for contents; watermarking a contents duplication process (history) on the requested contents in realtime, based on execution of a realtime watermarking program; and transferring the watermarked contents to the user.

### BRIEF DESCRIPTION OF THE DRAWINGS

The above object and other advantages of the present invention will become more apparent by describing the preferred embodiment thereof in more detail with reference to the accompanying drawings in which:

FIG. 1 shows a configuration of a realtime digital watermarking system in whole according to the present invention; and

FIG. 2 is a flow-chart view showing an operation method for running a realtime digital watermarking system according to the present invention.

### DETAILED DESCRIPTION OF THE INVENTION

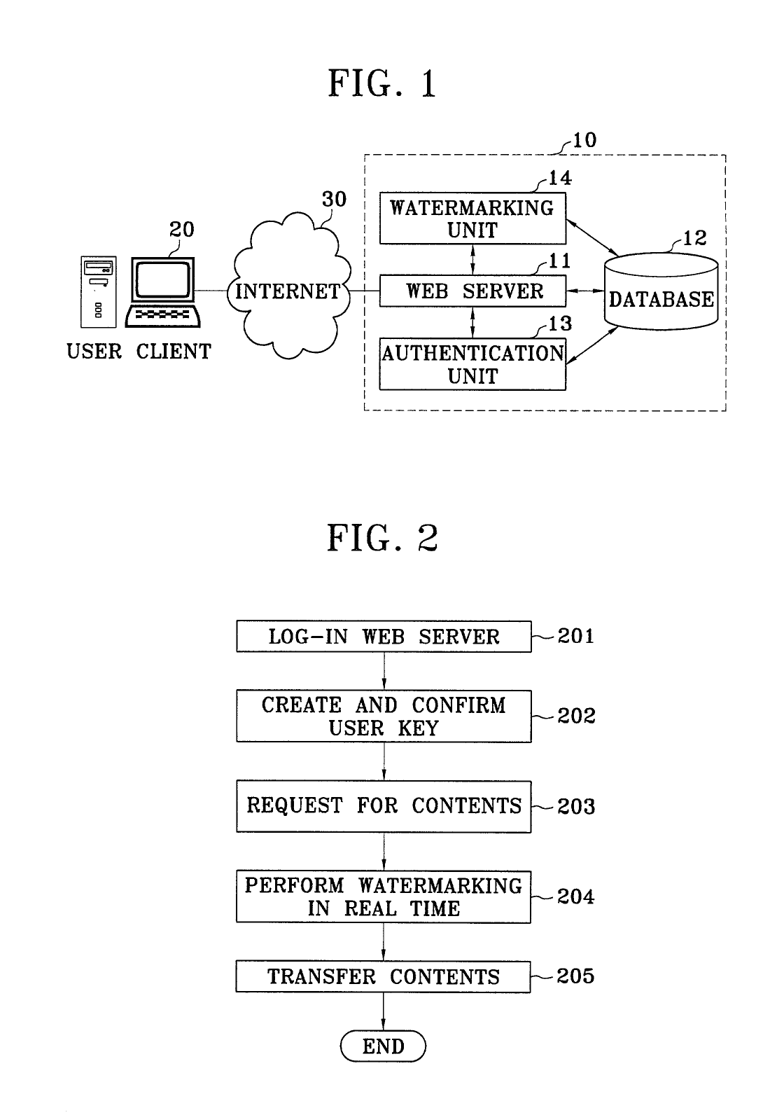

Referring to FIG. 1, an operator server 10 is a computer system that is operated by a content provider, and provides digital contents such as audio, video and image files through the Internet.

A user client 20 is a computer system having accessed the operator server 10, for requesting contents from the operator server 10. The Internet 30 is a connection path enabling data communications, for mutually connecting the operator server 10 and the user client 20.

The operator server 10 operates and manages a web site on the Internet 30, and includes a web server 11 providing a web document to the user client 20 when the user client 20 accesses the operator server 10; a database 12 for storing data necessary for operating the whole system including content-related information and user information such as an identification (ID); an e-mail address and a user key. An authentication unit 13 detects whether the user accesses the web server 11, creating a user key for user authentication if a user access has been detected, and then storing the user key in the database 12. Also provided is a watermarking unit 14 for watermarking information indicating a contents duplication process (history) such as the user ID, the user key, a request time and a user computer Internet Protocol (IP) address on the contents to be transferred, when the user accessed the web server 11 and requests transferring contents based on execution of the real-time watermarking program of the invention, and extracting watermarked secret information.

The user gains access to the web site operated in the web server 11 and receives necessary contents. The watermarking for creating the user key for authentication and inserting data into the contents is automatically accomplished by mutual linkage of the respective elements 11, 12, 13 and 14 in the operator server 10. The operation of the operator server 10 will be described below.

FIG. 2 is a flow-chart view showing an operation method for running a realtime digital watermarking system according to the present invention, where a preferred embodiment of the present invention will be described below with reference to FIGS. 1 and 2.

First, a user accesses the web server 11 in order to receive necessary contents from the operator server 10 providing user desired information, such as a digital file. The user then inputs user personal information requested by the operator server 10 to perform user registration.

The user is assigned with a his or her own unique identification (ID) through user registration and performs a log-in to enter the web server 10 using the ID (step 201).

The authentication unit 13 creates a user key for user authentication of the log-in user immediately after the user client 29 logged in the web server 11. The user key can be any combination or alpha/numeric/alpha-numeric characters generated by the server 10, by various means that are well known in the art. The thus-created user key matches or is associated with the user ID and is stored in the database 12. Then, the user key is transferred to the user and then the user confirms the user key (step 202).

As an example of transferring the user key to the user, a user's e-mail address received at the time of the user registration is used. That is, if the authentication unit 13 creates a user key, a mail server (not shown) is utilized by the authentication unit 13 and the user key is transferred at the previously stored user's e-mail address.

The user confirms the user key transferred at his or her e-mail address, and then inputs the user key in a corresponding input column in the web server 11 within a certain time, e.g., thirty minutes after receiving an electronic mail, to thereby undergo user authentication.

If the user does not input the user key within a certain time, a corresponding user key becomes invalid. In this case, the user logs in the web server 11 again, in order to receive a newly created user key.

The authenticated user duplicates or downloads his or her desired content to the user client 20, among the content displayed on the web site. That is, the user client 20 requests for transfer of contents to the web server 11 (step 203).

Then, the watermarking unit 14 watermarks information in the content to be transferred. Immediately before the transfer, the web server 11 searches the database 12, finds corresponding contents and transfers the found contents to the user client 20 (step 204). That is, if the user client 20 requests transfer of content through the web server 11, the watermarking unit 14 detects the contents transfer request based on execution of a realtime watermarking program and then searches the previously stored user's ID, the user key assigned to the corresponding user and the requested contents. Also, the searched data is coded together with a time at which the user client 20 accessed the web server 11 (or a time at which the contents transfer has been requested for), an Internet Protocol (IP) address of the user client 20 and so on, and thus watermarked in the contents.

Information from which a content movement procedure (history), that is, concerning by whom (user ID), when (contents request time) and from which computer (user client IP address) contents have been requested for and duplicated can be clearly judged is watermarked in the corresponding contents.

The watermarked information is stored in the contents and separately stored in the database 12 as well. Since the watermarked information is stored in the database 12, it is possible to effectively manage and monitor contents that are duplicated or downloaded to the outside. Also, even in the case that various persons duplicate the same contents at the same time, respectively different information is automatically watermarked that is, the same information will receive differing watermarks.

At the above-described realtime watermarking process, the watermarking unit 14 does not watermark information by digitizing the information to be watermarked and performing a simple watermarking on the contents, but uses an encrypted algorithm, that is, encrypts information and performs watermarking of the encrypted information, to thereby prevent alteration or damage due to an abnormal extraction of the watermarked information.

In other words, since an encryption applied at the time of watermarking should be solved in order to extract the information watermarked on the contents, the watermarked information can be extracted only from the operator server 10 where a realtime watermarking program is executed. In the case of a system where a realtime watermarking program is not executed, it cannot be seen whether there has been a watermarking.

As described above, if a realtime watermarking has been completed, the web server 11 transfers the watermarked contents to the user client 20 (step 205).

As an extraction method of extracting the watermarked information by the watermarking unit 14 based on the execution of the realtime watermarking program, the watermarking unit 14 duplicates all web documents (including sub-directories of the corresponding web site) of other web sites including contents doubted as duplicated copies, and stores the duplicated web documents in the database 12.

The above execution is accomplished by operator's commands at the operator server 10. The watermarking unit 14 calls a conventional web browser or a specially produced user interface (dedicated browser) and then executes the called browser, to thereby display the stored web documents of the other web site on a screen (not shown) of the operator server 10.

In the case that a conventional web browser is used, there is no command for extracting the watermarked data in the web browser menu. Accordingly, when particular contents are double-clicked or a cursor is located over the corresponding contents and then a right-handed button of a mouse is clicked, an information extraction command is displayed so that the watermarking unit 14 can extract the watermarked information from the particular contents.

In the case that a particular user interface is used, the watermarked information can be extracted from the particular contents through a command menu for information extraction, which is more preferable.

The watermarking unit 14 having received an information extraction command decodes the encrypted algorithm and extracts all the watermarked information, based on execution of the realtime watermarking program. As a result, it can be seen easily that contents have been requested for and duplicated by whom (user ID), when (contents request time) and from which computer (user client IP address), which provides a good evidence with respect to illegal duplication.

As described above, fixed information is not watermarked on digital contents in advance, but a digital contents duplication process (history) is encrypted using an encrypted algorithm in realtime and watermarked on the digital contents automatically when a duplication of the digital contents occurs on the Internet. Accordingly, there is no need to perform a watermarking of information every time when contents are produced. Also, respectively different information can be watermarked on all contents, or even the same contents. Further, the encrypted algorithm can prevent abnormal extraction and alteration of the watermarked information.

Modifications and substitutions by one of ordinary skill in the art are considered to be within the scope of the present invention which is not to be limited except by the claims which follow.

What is claimed is:

1. A digital watermarking system using an encrypted algorithm, the digital watermarking system comprising:
an operator server for storing and providing contents, for creating and assigning a user key for authentication to an accessing person, for watermarking information in the contents requested for by the accessing person using the authentication user key, in realtime and for extracting watermarked information from the watermarked contents;
a user client having accessed the operator server, for requesting for and receiving necessary contents from the operator server; and
a computer network connecting the operator server and the user client.

2. The digital watermarking system of claim 1, wherein said operator server watermarks a content in connection with a duplication process (history) of the contents, said watermark a function of the contents have been requested and duplicated, by whom (user ID), when (contents request time) and from which computer (user client IP address).

3. The digital watermarking system of claim 1, wherein said operator server comprises:
a web server providing a web document to the user client when the user client accesses the operator server;
a database for storing data necessary for operating the whole system, which includes contents-related information and user information such as an identification (ID), an e-mail address and a user key;
an authentication unit for detecting whether the user accesses the web server, creating a user key for user authentication if a user access has been detected, and then storing the user key in the database, and
a watermarking unit for watermarking information indicating a contents duplication process (history) including at least one of the user ID, the user key, a request time and a user computer Internet Protocol (IP) address in the contents to be transferred, when the user accessed the web server requests for transferring contents based on execution of a realtime watermarking program, and extracting said watermarking information.

4. An operating method for running a realtime digital watermarking system, the operating method comprising the acts of:
(a) creating a user key for user authentication and issuing the user key to a log-in person having accessed an operator server, using a previously registered user's identification (ID);
(b) the user requesting for contents;
(c) watermarking a contents duplication process (history) on the requested contents in realtime, based on execution of a realtime watermarking program; and
(d) transferring the watermarked contents to the user.

5. The operating method of claim 4, further comprising the step of extracting all the watermarked information from the watermarked contents based on the execution of the realtime watermarking program.

6. The operating method of claim 4, wherein watermarking is encrypted in order to prevent alteration and damage of the watermarked information.
